(19) United States
(12) Patent Application Publication
(10) Pub. No.: US 2026/0257481 A1
(43) Pub. Date: Sep. 3, 2026

(54) INKJET RECORDING APPARATUS, TEMPERATURE CONTROL METHOD, AND STORAGE MEDIUM

(71) Applicant: Konica Minolta, Inc., Tokyo (JP)

(72) Inventor: Yousuke TAKASHIMA, Tokyo (JP)

(21) Appl. No.: 19/542,928

(22) Filed: Feb. 18, 2026

(30) Foreign Application Priority Data
Feb. 28, 2025 (JP) 2025-030848

(51) Int. Cl. B41J 2/175; B41J 2/19; B41J 2/195

(52) U.S. Cl. CPC B41J 2/175; B41J 2/19; B41J 2/195

(57) ABSTRACT

An inkjet recording apparatus includes: an inkjet head that ejects ink; a liquid delivery section that delivers the ink; an adjustment section that adjusts an ink temperature in the liquid delivery section at an upstream side of the inkjet head; and a hardware processor. The hardware processor defoams the ink by causing the adjustment section to adjust the ink temperature in the liquid delivery section at the upstream side.

### CROSS-REFERENCE TO RELATED APPLICATIONS

The entire disclosure of Japanese Patent Application No. 2025-030848 filed on Feb. 28, 2025, is incorporated herein by reference in its entirety.

### BACKGROUND OF THE INVENTION

### Technical Field

The present disclosure relates to an inkjet recording apparatus, a temperature control method, and a storage medium.

### Description of Related Art

There is known a droplet ejection apparatus (inkjet recording apparatus) that ejects droplets from a droplet ejection head. The droplet ejection apparatus includes a plurality of tanks containing liquid. The tanks are provided with, for example, a float switch as a measurement section that measures a liquid level of the liquid.

When the ink is heated in the ink supply channel, the air dissolved in the ink and the air taken in a dispersed state while the ink is stirred in the ink tank are ejected as air bubbles into the channel during liquid sending and heating. Thus, bubbles may accumulate in the channels and the tanks. When the ink foams, its density decreases. Accordingly, the buoyancy acting on the float switch decreases, and the measurement section may wrongly detect the liquid level. When the air bubbles grow, the pressure-adjusting air channel provided at the upper part of the tank may be contaminated. It is necessary to suppress apparatus troubles and a quality decrease owing to the air bubbles.

Since the ink flow rate varies depending on the print pattern, foaming cannot be restrained if the temperature is set to a fixed level. There is known a recording head cartridge that keeps residual bubbles in ink channels at a high temperature and collects and discharges the coalesced bubbles (see Japanese Unexamined Patent Application Publication No. 2011-224851). There is also known a print head assembly for an inkjet printer (see JP2012-162078A). The print head assembly pressurizes and heats a phase change ink so that bubbles are moved and discharged. The print head assembly forms liquid-phase ink and solid-phase ink in ink channels by setting temperatures in a gradient manner in the ink channels. The print head assembly fills voids in the solid phase by infiltrating the liquid into the voids by a pressure difference generated by a temperature difference and pressure application.

### SUMMARY OF THE INVENTION

However, the above recording head cartridge is mainly used in maintenance. The cartridge cannot remove air bubbles generated in the ink heating process of continuous printing without interrupting printing. Further, although the above print head assembly may be effective in maintenance during warm-up, the assembly may not be effective during printing operations. Further, JP2012-162078A also describes removing air from the head free surface together with ink. It is considered that air bubbles are ejected together with ink. This may affect print quality. For this reason, JP2012-162078A may cause a problem by discharging air from the head. Further, the bubble removal degree may not be sufficiently controlled by controlling the pressure and the temperature in the printing operation in which the ink flow amount and the head temperature change.

An object of the present disclosure is to reduce air bubbles in ink during the printing operation.

To achieve at least one of the abovementioned objects, according to an aspect of the present invention, an inkjet recording apparatus includes: an inkjet head that ejects ink; a liquid delivery section that delivers the ink; an adjustment section that adjusts an ink temperature in the liquid delivery section at an upstream side of the inkjet head; and a hardware processor that defoams the ink by causing the adjustment section to adjust the ink temperature in the liquid delivery section at the upstream side.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a side view of an inkjet recording apparatus according to an embodiment of the present disclosure;

FIG. 2 is a schematic diagram of a liquid delivery section;

FIG. 3 is a block diagram of part of the liquid delivery section;

FIG. 4 is a block diagram of a functional configuration of the inkjet recording apparatus;

FIG. 5 is a flowchart of a temperature control process;

FIG. 6 illustrates a setting table;

FIG. 7 illustrates a setting table;

FIG. 8 illustrates the characteristics of a preset dissolving-section ink temperature corresponding to a first sub-tank ink temperature;

FIG. 9 illustrates the characteristics of a preset first-sub-tank ink temperature corresponding to the dissolving-section ink temperature;

FIG. 10 illustrates ink temperature with respect to ink discharge time in an example;

FIG. 11 illustrates ink temperature with respect to ink discharge time in a comparative example; and

FIG. 12 illustrates an example of temporal characteristics of the dissolving-section ink temperature, the preset first-sub-tank ink temperature, the first-sub-tank ink temperature, and the preset dissolving-section ink temperature.

### DETAILED DESCRIPTION

Advantages and features provided by one or more embodiments of the present disclosure will be more fully understood from the following detailed description and the accompanying drawings. However, these drawings are for illustration purposes only and are not intended to define the limits of the present disclosure. Hereinafter, embodiments of the present disclosure will be described with reference to the drawings. However, the scope of the present disclosure is not limited to the disclosed embodiment.

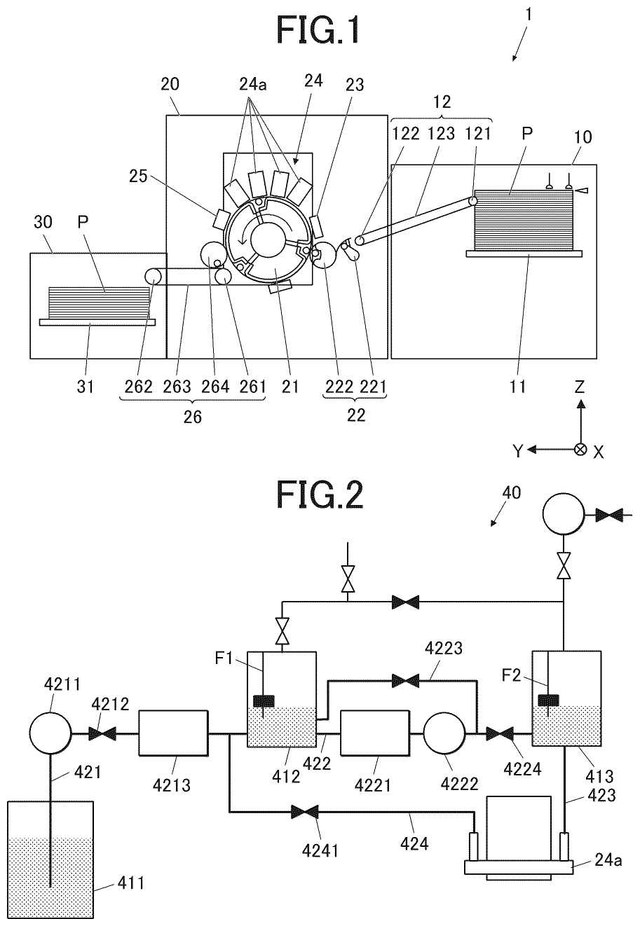

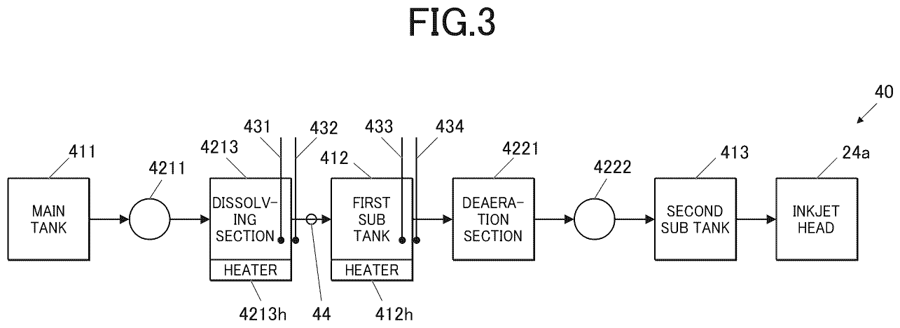

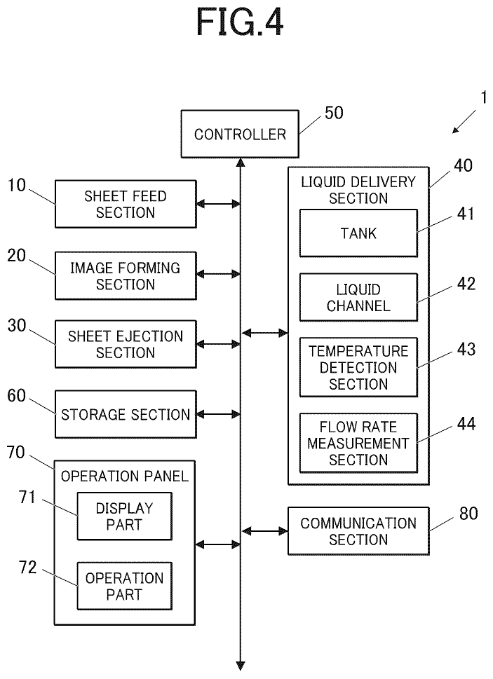

A first embodiment of the present disclosure will be described with reference to FIG. 1 to FIG. 12. First, the configuration of a recording apparatus according to the embodiment will be described with reference to FIG. 1 to FIG. 4. FIG. 1 is a side view of the inkjet recording apparatus 1 of the present embodiment. FIG. 2 is a schematic diagram of a liquid delivery section 40. FIG. 3 is a block diagram of part of the liquid delivery section 40. FIG. 4 is a block diagram illustrating a functional configuration of the inkjet recording apparatus 1.

With reference to FIG. 1, the overall configuration of the inkjet recording apparatus 1 is described. The inkjet recording apparatus 1 includes a sheet feed section 10, an image forming section 20, and a sheet ejection section 30. The inkjet recording apparatus 1 conveys the recording medium P from the sheet feed section 10 to the image forming section 20. The image forming section 20 forms an image on the recording medium P with the ink supplied from the liquid delivery section 40 (see FIG. 2 to FIG. 4). After the image formation, the sheet ejection section 30 and the controller 50 (hardware processor) eject the recording medium P to the sheet ejection tray 31.

The recording medium P is a piece of paper, such as plain paper or coated paper, but is not limited thereto. The recording medium P may be any kind of medium, such as a textile or resin sheet, on the surface of which the ink can be landed and fixed.

FIG. 1 shows the X axis, Y axis, and Z axis in three dimensions. The +X direction, the +Y direction, and the +Z direction are also referred to as the width direction, the conveyance direction, and the height direction, respectively.

The sheet feed section 10 stores the recording media P before image formation and conveys the recording media P to the image forming section 20. The sheet feed section 10 includes a sheet feed tray 11 and a conveyance section 12. The sheet feed tray 11 is a plate member that stores the recording media P. On the sheet feed tray 11, one or more recording media P can be placed. The sheet feed tray 11 moves up and down according to the amount of the recording media P placed thereon. The sheet feed tray 11 is moved upwards and downwards and kept at a position where the uppermost recording medium P is conveyed by the conveyance section 12.

The conveyance section 12 conveys the recording medium P from the sheet feed tray 11 to the image forming section 20. The conveyance section 12 includes a conveyance mechanism. The conveyance mechanism drives the belt 123 to convey the recording medium P on the belt 123. The belt 123 has a loop shape, and the inside of the loop is supported by rollers 121 and 122. The conveyance section 12 delivers the uppermost recording medium P placed on the sheet feed tray 11 onto the belt 123 and conveys the recording medium P along the belt 123.

The image forming section 20 forms an image on the recording medium P in cooperation with the liquid delivery section 40. The image forming section 20 includes an image forming drum 21, a handover unit 22, a sheet heater 23, head units 24, an irradiation unit 25, and a delivery unit 26.

The image forming drum 21 carries the recording medium P along its cylindrical outer surface and conveys the recording medium P with rotation. The conveyance surface of the image forming drum 21 faces the sheet heater 23, the head units 24, and the irradiation unit 25 to perform image formation processing on the conveyed recording medium P.

The handover unit 22 is at a position between the conveyance section 12 and the image forming drum 21. The handover unit 22 includes a claw 221 and a handover drum 222. The claw 221 is a cylindrical part that holds one end of the recording medium P conveyed by the conveyance section 12. The handover drum 222 guides the recording medium P held by the claw 221. The handover unit 22 picks up the recording medium P on the conveyance section 12 with the claw 221 and places the recording medium P along the outer peripheral surface of the handover drum 222. Thus, the handover unit 22 passes the recording medium P to the image forming drum 21.

The sheet heater 23 includes a heating wire, for example, and generates heat in response to energization. Under the control of the controller 50, the sheet heater 23 generates heat so that the recording medium P passing near the sheet heater 23 has a predetermined temperature. The sheet heater 23 is provided near the outer circumferential surface of the image forming drum 21 and on the upstream of the head units 24 in the conveyance direction of the recording medium P. A temperature sensor (not illustrated) is provided near the sheet heater 23. With the temperature sensor, the controller 50 (see FIG. 4) detects the temperature in the vicinity of the sheet heater 23. Based on the detected temperature, the controller 50 controls heat generation of the sheet heater 23.

The head units 24 include, for example, inkjet heads 24a and a carriage on which the inkjet heads 24a are mounted. The head units 24 eject ink droplets from nozzles onto the recording medium P to form an image. The head units 24 corresponding to the colors of C (cyan), M (magenta), Y (yellow), and K (black) are provided. In FIG. 1, the head units 24 corresponding to the colors of Y, M, C, and K are provided in this order from the upstream of the conveyance direction of the recording medium P.

The head units 24 of the present embodiment each cover the entire width of the recording medium P in the width direction. That is, the inkjet recording apparatus 1 is a one-pass line-head inkjet recording apparatus. The inkjet heads 24a of the head units 24 are arranged in the conveyance direction. The number of head units 24 may be more or less than four. The head unit 24 may consist of a single inkjet head 24a.

The ink ejected by the head units 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the polymerization initiator, so that the ink is fixed to the recording medium P.

The ink ejected by the head units 24 may be phase-change gel ink containing a gelling agent. The phases of the phase-change gel ink change between the gel state (solid phase) and the liquid (sol) state (liquid phase) according to temperature. The phase change temperature of the gel ink is in the range of about 40 to 100° C., for example. The gel ink is uniformly liquefied (solated) by being heated to the phase change temperature or higher. At normal room temperature, namely around 0 to 30° C., the gel ink is gelatinized. Therefore, the ink in the head units 24 is in the sol state by being heated to an appropriate temperature by an ink heater or the like (not illustrated). After being ejected and landed on the recording medium P, the ink moderately transfers to the gel state while being conveyed by the image forming drum 21.

The irradiation unit 25 includes a fluorescent tube, such as a low-pressure mercury lamp. The irradiation unit 25 emits energy rays such as ultraviolet rays by light emission of the fluorescent tube. The irradiation unit 25 is provided near the outer surface of the image forming drum 21. The irradiation unit 25 is provided on the downstream of the head units 24 in the conveyance direction of the recording medium P. The irradiation unit 25 emits the energy rays to the recording medium P on which the ink has been ejected. By the action of the energy rays, the UV ink on the recording medium P is cured.

The fluorescent tube that emits ultraviolet rays is not limited to the low-pressure mercury lamp. The fluorescent tube may be a mercury lamp having an operating pressure of a few hundred Pa to 1 MPa, for example. The fluorescent tube may be a light source usable as a bactericidal lamp, such as a cold-cathode tube, an ultraviolet laser light source, a metal halide lamp, or a light-emitting diode, for example. The fluorescent tube is desirably a power-saving light source capable of emitting ultraviolet rays with higher illuminance. The fluorescent tube is a light emission diode, for example. The energy rays are not limited to ultraviolet rays and may be any energy rays that cure the ink depending on the property of the ink. The light source is changeable depending on the energy rays.

In the above description, the head units 24 eject the UV ink or the phase-change gel ink. However, the invention is not limited thereto. The ink ejected by the head units 24 may be water-based ink or ink having other physical properties.

The delivery unit 26 includes a conveyance mechanism. The conveyance mechanism drives the loop-shaped belt 263 the inner side of which is supported by the rollers 261 and 262 to convey the recording medium P. The delivery unit 26 includes a cylindrical handover roller 264. The handover roller 264 passes the recording medium P from the image forming drum 21 to the conveyance mechanism. The delivery unit 26 conveys the recording medium P passed onto the belt 263 by the handover roller 264 to the sheet ejection section 30.

The recording medium P on which the image has been formed by the image forming section 20 is ejected to the sheet ejection section 30. The sheet ejection section 30 includes a plate-shaped sheet ejection tray 31. The recording medium P sent out from the image forming section 20 by the delivery unit 26 is placed on the sheet ejection tray 31. The sheet ejection section 30 stores the recording medium P until the user takes out the recording medium P.

Next, the liquid delivery section 40 will be described with reference to FIG. 2 and FIG. 3. In FIG. 2, multiple inkjet heads 24 are omitted, and a single inkjet head 24 is illustrated as a representative. The liquid delivery section 40 includes tanks 41, a liquid channel 42, a temperature detection section 43, and a flow rate measurement section 44 (see FIG. 4).

The tanks 41 store ink. The tanks 41 are made of metal, for example, and have a rigid sealed structure. The tanks 41 include a main tank 411, a first sub tank 412, and a second sub tank 413. The main tank 411 stores each color ink to be supplied to each part of the liquid delivery section 40. Although omitted in FIGS. 2 and 3, the main tanks 411 corresponding to the respective colors of ink are provided. The ink is supplied to the inkjet head 24 via a first liquid channel 421, the first sub tank 412, a second liquid channel 422, the second sub tank 413, and a third liquid channel 423, which are described later, in this order. The entire body of the main tank 411 is replaceable. The main tank 411 is detachable from the first liquid channel 421 regardless of the operating state of a first liquid delivery section 4211, which is described later.

The first sub tank 412 temporarily stores and keeps warm the ink supplied from the main tank 411. Since the liquid delivery section 40 includes the first sub tank 412, a pressure change caused by pulsation when the first liquid delivery section 4211 supplies the ink from the main tank 411 is reduced. The ink that was not discharged from the nozzles of the inkjet head 24 is collected from the outlet to the first sub tank 412. The second sub tank 413 temporarily stores the ink to be delivered to the inkjet head 24a. The second sub tank 413 is provided with a back pressure adjustment means (not illustrated). The back pressure adjustment means applies appropriate negative pressure to the inkjet head 24a to prevent leakage of ink from the inkjet head 24a. Hereinafter, the first sub tank 412 and the second sub tank 413 will be simply referred to as the sub tank(s) when they are not particularly distinguished from each other.

The first sub tank 412 and the second sub tank 413 are provided with liquid level sensors F1 and F2, respectively. The liquid level sensors F1 and F2 each obtain information on the amount of ink in the sub tank to which the sensor is attached. Specifically, the liquid level sensors F1 and F2 each obtain the position of the liquid level in the sub tank and transmit the obtained data to the controller 50. The controller 50 obtains the liquid level height in the sub tank, based on the data. The liquid level sensors F1 and F2 are float sensors each including a non-illustrated float, sensor, and magnetic material. The liquid level sensors F1 and F2 are not limited to the float sensors. For example, a capacitance sensor that uses the electric field may measure the liquid level height in the sub tank.

The sub tank includes a heater that keeps the ink in the tank at an appropriate temperature. As illustrated in FIG. 3, the first sub tank 412 includes a heater 412h as a second heater. The heater 412h heats the ink stored in the first sub tank 412 under the control of the controller 50. The heater 412h includes a heater main body and a heat transfer member that transfers heat from the heater main body to the ink. The heater main body is, for example, a heating wire that generates Joule heat when energized. The heat transfer member is a heat transfer plate formed of a member having a high heat conductivity, such as metals (alloys), for example.

The sub-tank is provided with a non-illustrated pressure sensor capable of measuring internal pressure values and an air path shown in FIG. 2. The air path is provided with a non-illustrated pneumatic pump that sucks the air in each sub-tank to reduce the pressure under the control of the controller 50. Thus, the pressure in each sub tank is controlled. For example, when the controller 50 sends air from the second sub tank 413 to the first sub tank 412, the pressure inside the first sub tank 412 is higher than the pressure inside the second sub tank 412. Thus, the ink in the first sub tank 412 is delivered to the second sub tank 413.

The liquid channel 42 is an ink channel that connects the main tank 411 through to the inkjet head 24a so as to enable a return flow. The liquid channel 42 includes the first liquid channel 421, the second liquid channel 422, the third liquid channel 423, and the fourth liquid channel 424. The liquid channel 42 preferably has ink resistance. The liquid channel 42 has a hollow annular tube structure.

The first liquid channel 421 connects the main tank 411 to the first sub tank 412. The first liquid channel 421 is provided with the first liquid sending section 4211, a supply valve 4212, and a dissolving section 4213. The first liquid delivery section 4211 sends the ink in the main tank 411 to the first sub tank 412. Based on the measurement by the liquid level sensor F1, when the controller 50 determines that the liquid amount in the first sub tank 412 is a predetermined lower limit value, the controller 50 drives the first liquid delivery section 4211 for a predetermined period to send the ink from the main tank 411 to the first sub tank 412.

The first liquid delivery section 4211 is a pump, for example, but is not limited thereto. When the first liquid sending portion 4211 is a pump, a diaphragm pump is preferable from the viewpoints of durability, cost, size, and variety of types. The supply valve 4212 is, for example, an electromagnetic valve. Under the control of the controller 50, the supply valve 4212 selectively opens the first liquid channel 421 when the first liquid delivery section 4211 is driven.

The dissolving section 4213 is a heating unit that stores therein the ink sent from the main tank 411 and heats and dissolves the ink. Under the control of the controller 50, the dissolving section 4213 heats the ink flowing through the first liquid channel 421 to a predetermined temperature to reduce the viscosity of the ink. As illustrated in FIG. 3, the dissolving section 4213 includes a heater 4213h as a first heater. The heater 4213h heats the ink stored in the tank of the dissolving section 4213 under the control of the controller 50. The configuration of the heater 4213h is similar to the heater 412h, for example.

The second liquid channel 422 connects the first sub tank 412 to the second sub tank 413. The second liquid channel 422 is provided with a deaeration section 4221, a second liquid delivery section 4222, a circulation channel 4223, and a circulation valve 4224. The deaeration section 4221 is a deaeration module that removes gas dissolved in the ink that passes through the module. The deaeration section 4221 includes a gas-permeable film. The gas-permeable film is depressurized by being made airtight and sucking the inside air. When the ink is in contact with the gas-permeable film of the deaeration section 4221, the gas dissolved in the ink is passed through the gas-permeable film by the pressure difference. Thus, the gas dissolved in the passed ink is removed.

The second liquid delivery section 4222 sends the ink from the first sub tank 412 to the second sub tank 413. When the controller 50 determines that the liquid amount in the second sub tank 413 is a predetermined lower limit value, based on the measurement by the liquid level sensor F2, the controller 50 drives the second liquid delivery section 4222 for a predetermined period to send the ink in the first sub tank 412. When the second liquid delivery section 4222 is a pump, it is preferable that the second liquid delivery section 4222 be a diaphragm pump for the same reason as the first liquid sending portion 4211.

The circulation channel 4223 branches from the position at the downstream side of the second liquid delivery section 4222 in the liquid delivery direction and at the upstream side of the circulation valve 4224 in the liquid delivery direction. The circulation channel 4223 has a channel that communicates with the first liquid channel 421 between the supply valve 4212 and the dissolving section 4213. With such a configuration, when the controller 50 closes the circulation valve 4224 and drives the second liquid delivery section 4222, the ink delivered from the first sub tank 412 passes through the dissolving section 4213 and returns to the first sub tank 412. Therefore, a decrease or unevenness in the ink temperature can be suppressed when the supply of the ink is stopped. The circulation valve 4224 is an electromagnetic valve and selectively opens the second liquid channel 422 when the second liquid delivery section 4222 is driven.

On the upstream of the second liquid delivery section 4222 of the second liquid channel 422 in the liquid delivery direction, a known deaeration module that removes air in the ink or a known filter that collects foreign substance in the ink may be provided. With such a module or filter, deterioration of the second liquid delivery section 4222 can be suppressed. Further, foreign substances in the ink can be removed when the ink is circulated as described above.

The third liquid channel 423 connects the second sub tank 413 to the inlet of the inkjet head 24a. The fourth liquid channel 424 connects the outlet of the inkjet head 24a to the first sub tank 412. The fourth liquid channel 424 is provided with a second circulation valve 4241 that is an electromagnetic valve. Under the control of the controller 50, the second circulation valve 4241 selectively opens the fourth liquid channel 424 when the ink is circulated from the inkjet head 24a to the first sub tank 412.

The temperature detection section 43 detects the temperature of the ink in the dissolving section 4213 and in the first sub tank 412. As illustrated in FIG. 3, the temperature detection section 43 includes temperature detection sections 431, 432, 433, and 434. The temperature detection section 431 as a second temperature detector is provided near the outlet in the tank of the dissolving section 4213. The temperature detection section 431 detects the temperature of the ink to be delivered and outputs the detected temperature information to the controller 50. The temperature detection section 432 as a first temperature detector is provided to the tank of the dissolving section 4213. The temperature detection section 432 detects the temperature of the tank and outputs the detected temperature information to the controller 50. The temperature detection section 433 is provided to the tank of the dissolving section 4213. The temperature detection section 433 detects the temperature of the tank and outputs the detected temperature information to the controller 50. The temperature detection section 432 is provided to the tank of the first sub tank 412. The temperature detection section 434 detects the temperature of the tank and outputs the detected temperature information to the controller 50.

The flow rate measurement section 44 measures the flow rate of ink fed from the dissolving section 4213 to the first sub tank 412. The flow rate measurement section 44 is a clamp-type flowmeter, for example. The flow rate measurement section 44 measures the flow rate [cc/s] of the ink fed from the dissolving section 4213 and outputs the measured ink flow rate to the controller 50.

The internal functional configuration of the inkjet recording apparatus 1 will be described with reference to FIG. 4. The inkjet recording apparatus 1 includes the sheet feed section 10, the image forming section 20, the sheet ejection section 30, the liquid delivery section 40, the controller 50, the storage section 60, the operation panel 70, and the communication section 80. These parts of the inkjet recording apparatus 1 are connected via a bus. The operation panel 70 includes a display part 71 and an operation part 72.

The controller 50 includes a central processing unit (CPU), a random access memory (RAM), and a read only memory (ROM). The controller 50 centrally controls operations of each section of the inkjet recording apparatus 1. The CPU reads various programs stored in the ROM, loads the read program in the RAM, and carries out various processes in cooperation with the loaded program. The RAM provides the CPU with a working memory space and temporarily retains data. The ROM stores various programs and setting data. Specifically, the ROM stores a temperature control program for executing a temperature control process, which is described later. The ROM may be a storage section from which information is readable, such as a flash memory, for example.

The sheet feed section 10 feeds the recording medium P to the image forming section 20 under the control of the controller 50. The image forming section 20 forms an image on the recording medium P fed by the sheet feed section 10 by the inkjet recording method under the control of the controller 50. The sheet ejection section 30 ejects the recording medium P on which the image has been formed by the image forming section 20 under the control of the controller 50. The liquid delivery section 40 delivers the ink to the inkjet head 24a of the image forming section 20 under the control of the controller 50.

The storage section 60 stores print jobs and image data input from an external device, such as a personal computer (PC), via the communication section 80. Specifically, the storage section 60 stores setting tables 610 and 620 (described later) related to temperature settings in printing. The storage section 60 further stores target temperatures for the ink temperature of the dissolving section (dissolving-section ink temperature) and the ink temperature of the first sub tank (first-sub-tank ink temperature) in the standby state. Instead of the target temperatures for the dissolving-section ink temperature and the first-sub-tank ink temperature in the standby state, the storage section 60 may store the target temperatures for the dissolving-section tank temperature and the first-sub-tank temperature in the standby state.

The operation panel 70 includes the display part 71 that displays various kinds of information to a user and the operation part 72 that receives operations input by the user. The display part 71 consists of a liquid crystal display (LCD) or an electro luminescent display (ELD), for example. The display part 71 displays display information input by the controller 50.

The display information includes various setting screens, various buttons, and the operating state of each function. The operation part 72 includes a touch screen provided on the screen of the display part 71 and various hard keys arranged around the screen of the display part 71. The operation part 72 receives touch inputs and press inputs by the user and outputs the operation information to the controller 50. Specifically, the operation part 72 includes a power key for receiving an input to turn on or off the inkjet recording apparatus 1.

The communication section 80 is a communication module to be connected to an external device or a communication network, such as a local area network (LAN). The communication section 80 includes an input-output interface and/or a network card. The controller 50 sends and receives information to and from an external device over the communication network via the communication section 80.

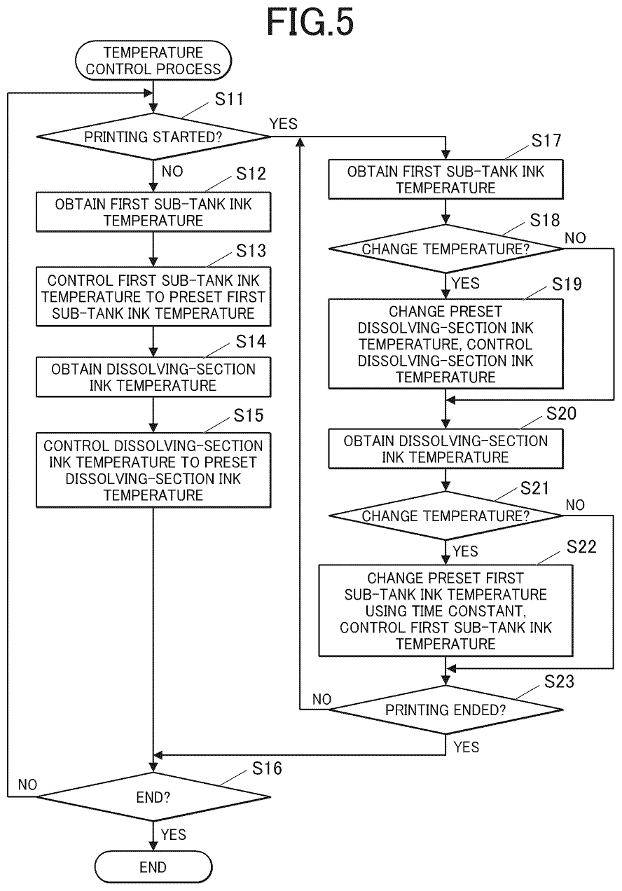

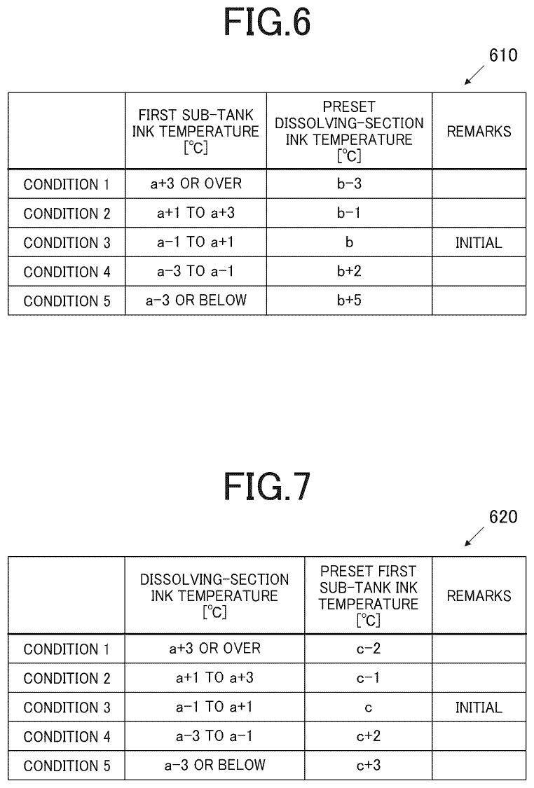

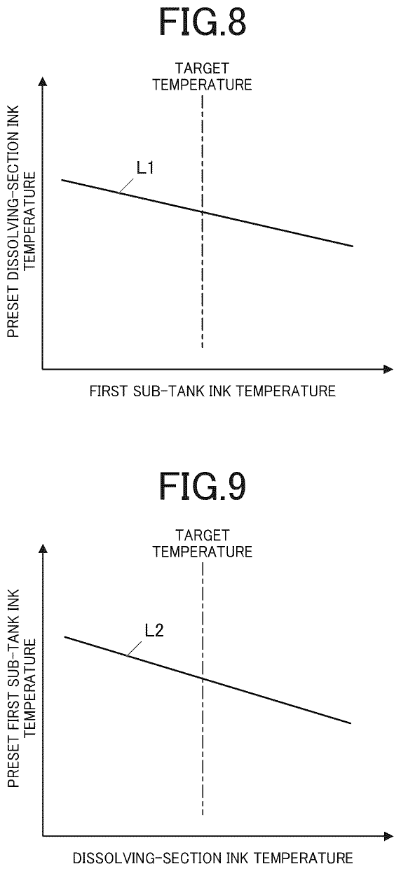

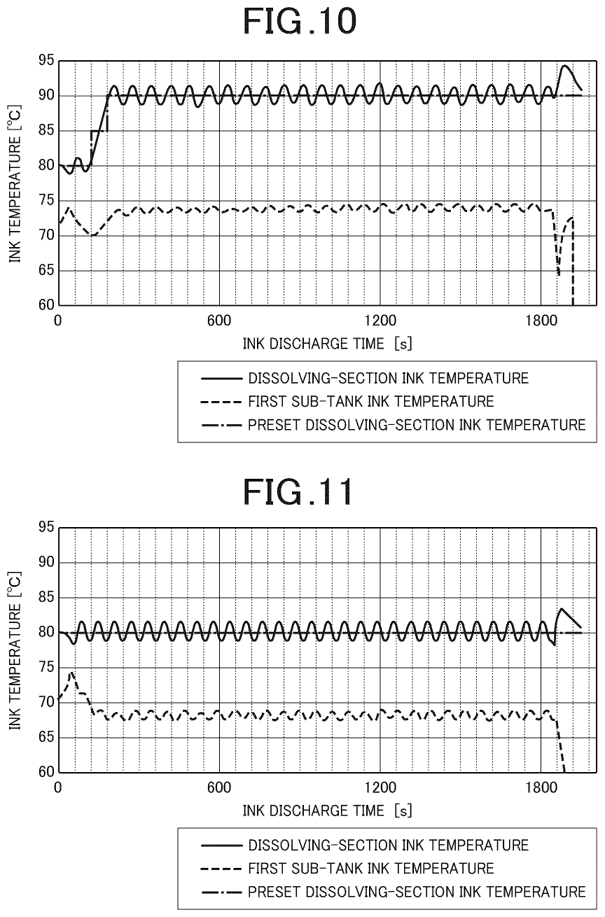

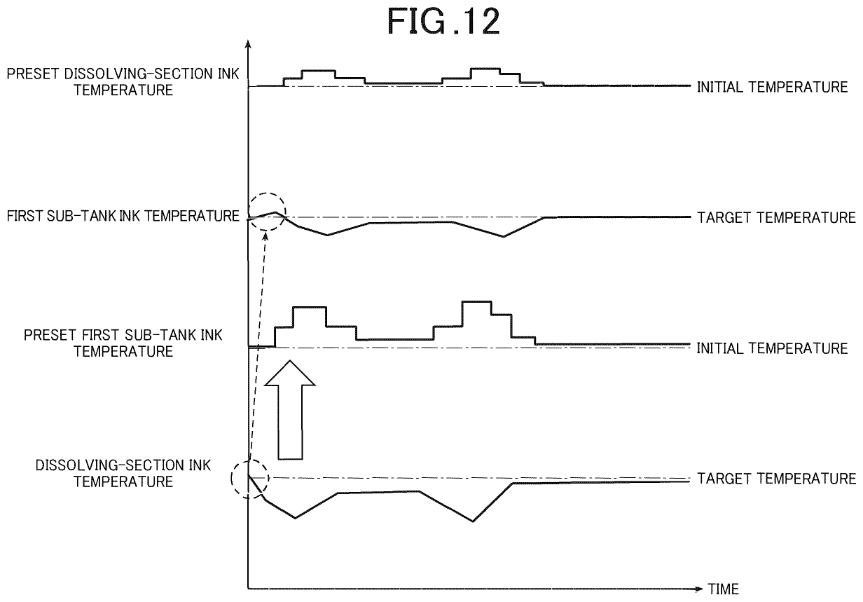

Next, operations of the inkjet recording apparatus 1 will be described with reference to FIG. 5 to FIG. 12. FIG. 5 shows the flowchart of the temperature control process. FIG. 6 shows the setting table 610. FIG. 7 shows the setting table 620. FIG. 8 shows the characteristics of the preset dissolving-section ink temperature corresponding to the first sub-tank ink temperature. FIG. 9 shows the characteristics of the preset first-sub-tank ink temperature corresponding to the dissolving-section ink temperature. FIG. 10 shows ink temperature with respect to ink discharge time in an example. FIG. 11 shows ink temperature with respect to ink discharge time in a comparative example. FIG. 12 shows an example of temporal characteristics of the dissolving-section ink temperature, the first-sub-tank ink temperature, the preset first-sub-tank ink temperature, and the preset dissolving-section ink temperature.

First, the foam mechanism of the ink will be described. Foaming is the state in which gases dissolved and dispersed in the liquid ink are released as bubbles when the temperature of the liquid ink is increased, for example. Foaming is inevitable for the UV ink and the phase-change gel ink, which are heated for use in the present embodiment. The stability of foam (bubbles) is related to the viscoelasticity of thin foam films (lamella) in the foam. The higher the viscosity of the liquid ink is, the more stable the foam is. Therefore, when the ink temperature is increased, the ink viscosity decreases and the foam becomes unstable. Accordingly, the foam is likely to disappear.

Further, when the ink temperature increases, the interfacial tension of the ink decreases, so that the ink is likely to foam. Since the air bubbles are coarse and large, the bubble membranes easily break when the bubbles are in contact with the air. The foam is considered to be broken when the defoaming agent having a small surface tension intrudes into the foam film, the surface tension of the intruded portion locally decreases, and the portion having the lower surface tension is pulled by the surrounding foam film having a higher surface tension. Accordingly, the foam is broken. Therefore, it is preferable that the ink temperature be controlled at a temperature appropriate for defoaming.

The temperature control process to be executed by the inkjet recording apparatus 1 will be described with reference to FIG. 5. In the temperature control process, the temperatures of the dissolving section 4213 and the first sub tank 412 are controlled when the inkjet recording apparatus 1 is on standby or in printing (image formation by the inkjet method). The storage section 60 stores beforehand the setting tables 610 and 620 and the measured channel volume [cc] of the channel between the dissolving section 4213 and the first sub tank 412.

The inkjet recording apparatus 1 receives input of power-on instruction information via the power key of the operation part 72 by the user. In response to receiving the input of the instruction information, the controller 50 executes the temperature control process in accordance with the temperature control program stored in the ROM.

In parallel with the temperature control process, the controller 50 executes a standby process for printing and a printing process. The standby process is the process of controlling the sheet feed section 10, the image forming section 20, the sheet ejection section 30, and the liquid delivery section 40 in the standby state after the user powers on the apparatus or after the printing process ends. The printing process is the process of forming an image on the recording medium P based on the designated image data by controlling the sheet feed section 10, the image forming section 20, the sheet ejection section 30, and the liquid delivery section 40 after the user inputs a printing instruction. The standby process and the printing process do not include controlling the temperatures of the dissolving section 4213 and the first sub tank 412 in the temperature control process.

First, the controller 50 determines whether printing by the printing process has been started (step S11). When printing has not been started (the apparatus is in the standby state) (step S11: NO), the controller 50 causes the temperature detection section 433 to detect the first-sub-tank ink temperature and obtains the detected temperature (step S12). From the storage section 60, the controller 50 reads the target temperature of the first sub-tank ink temperature in the standby state (step S13). In step S13, the controller 50 controls the heater 412h so that the obtained first-sub-tank ink temperature reaches the target temperature of the first-sub-tank ink temperature in the standby state. The heater 412h is controlled to perform heating or to stop heating.

In step S12, the controller 50 may cause the temperature detection section 434 to detect and obtain the first-sub-tank temperature. In this case, in step S13, the controller 50 reads out the target temperature of the first-sub-tank temperature in the standby state from the storage section 60. The controller 50 controls the heater 412h such that the obtained first-sub-tank temperature becomes equal to the preset first-sub-tank temperature in the standby state.

Next, the controller 50 causes the temperature detection section 431 to detect the dissolving-section ink temperature and obtains the detected temperature (step S14). From the storage section 60, the controller 50 reads out the target temperature of the dissolving-section ink temperature in the standby state (step S15). In step S15, the controller 50 controls the heater 4213h so that the obtained dissolving-section ink temperature becomes equal to the target temperature of the dissolving-section ink temperature in the standby state. The heater 4213h is controlled to perform heating or to stop heating.

In step S14, the controller 50 may cause the temperature detection section 432 to detect the dissolving-section tank temperature and may obtain the detected temperature. In this case, in step S15, the controller 50 reads the target temperature of the dissolving-section tank temperature in the standby state from the storage section 60. The controller 50 controls the heater 4213h so that the obtained dissolving-section tank temperature becomes the target temperature of the dissolving-section tank temperature in the standby state.

The controller 50 determines whether to end the temperature control process, based on the power-off input by the user via the power key of the operation part 72 (step S16). When determining not to end the temperature control process (step S16: NO), the controller 50 proceeds to step S11. When the controller 50 determines to end the temperature control process (step S16: YES), the temperature control process ends.

When printing has been started by the execution of the printing process (step S11: YES), the controller 50 causes the temperature detection section 433 to detect the first-sub-tank ink temperature and obtains the detected temperature (step S17). The controller 50 reads the setting table 610 in the storage section 60 (step S18). Herein, the setting table 610 will be described with reference to FIG. 6. The setting table 610 records the preset dissolving-section ink temperatures corresponding to the respective ranges of the first-sub-tank ink temperatures [° C.] in conditions 1 to 5. The temperature a [° C.] is the target temperature of the ink. The temperature b [° C.] is the initial value of the preset dissolving-section ink temperature. The setting table 610 is used to perform temperature control according to the straight line L1 of FIG. 8. The straight line L1 represents the relation between the first-sub-tank ink temperature and the preset dissolving-section ink temperature. In the straight line L1, when the first-sub-tank ink temperature is lower than the target temperature a, the preset dissolving-section ink temperature is increased from the temperature b to heat the dissolving section 4213. In the straight line L1, when the first-sub-tank ink temperature is higher than the target temperature a, the preset dissolving-section ink temperature is decreased from the temperature b, and heating of the dissolving section 4213 is stopped.

In step S18, the controller 50 determines whether to change the preset dissolving-section ink temperature to a different value in the setting table 610 corresponding to the acquired first-sub-tank ink temperature. When step S18 is executed for the first time, the preset dissolving-section ink temperature has been set to a temperature b (initial value).

When changing the preset dissolving-section ink temperature to a different value (step S18: YES), the controller 50 proceeds to step S19. In step S19, the controller 50 changes the preset dissolving-section ink temperature to a value corresponding to the acquired first-sub-tank ink temperature in the setting table 610. In step S19, the controller 50 controls the heater 4213h so that the dissolving-section ink temperature reaches the preset dissolving-section ink temperature in printing. The heater 4213h is controlled to perform heating or to stop heating.

Next, the controller 50 causes the temperature detection section 431 to detect the dissolving-section ink temperature and obtains the detected temperature (step S20). When not changing the preset dissolving-section ink temperature to a different value (step S18: NO), the controller 50 proceeds to step S20. The controller 50 reads out the setting table 620 from the storage section 60 (step S21). The setting table 620 will be described with reference to FIG. 7. The setting table 620 records the preset first-sub-tank ink temperatures corresponding to the respective ranges of the dissolving-section ink temperatures [° C.] in conditions 1 to 5. The temperature “c” [° C.] is an initial value of the preset first-sub-tank ink temperature. The setting table 620 is used to perform temperature control according to the straight line L2 of FIG. 9. The straight line L2 represents the relation between the preset first-sub-tank ink temperature and the dissolving-section ink temperature. When the dissolving-section ink temperature is lower than the target temperature “a” on the straight line L2, the preset first-sub-tank ink temperature is increased from the temperature “c” to heat the first sub tank 412. When the dissolving-section ink temperature is higher than the target temperature a on the straight line L2, the preset first-sub-tank ink temperature is decreased from the temperature c to stop heating of the first sub tank 412. When step S21 is executed for the first time, the preset first-sub-tank ink temperature has been set to the temperature c (initial value).

In step S21, the controller 50 determines whether to change the preset first-sub-tank ink temperature to a different value corresponding to the acquired dissolving-section ink temperature in the setting table 620. When changing the preset first-sub-tank ink temperature to a different value (step S21: YES), the controller 50 proceeds to step S22. In step S22, the controller 50 reads the channel volume from the storage section 60, causes the flow rate measurement section 44 to measure the ink flow rate, and obtains the measured flow rate. In step S23, the controller 50 calculates a time constant that indicates the ink delivery time from the dissolving section 4213 to the first sub tank 413, based on the following formula (1).

$$Time constant [ s ] = Channel volume [ {cm}^{3} ] \div Ink flow rate [ {cm}^{3} / s ] \qquad ( 1 )$$

Examples of the time constant [s] are listed in the following Table I.

TABLE I

| | CHANNEL | INK FLOW | TIME |
|---|---|---|---|
| | VOLUME | RATE | CONSTANT |
| | [cc] | [cc/s] | [s] |
| OUTLET OF | 100 | 6 | 17 |
| DISSOLVING | 100 | 3 | 33 |
| SECTION ↓ | 100 | 1 | 100 |
| FIRST SUB TANK | | | |

The controller 50 may calculate the time constant from image data difference.

In step S22, the controller 50 takes the time constant into consideration (e.g., after the time constant) and changes the preset first-sub-tank ink temperature to the value corresponding to the acquired dissolving-section ink temperature in the setting table 620. In step S22, the controller 50 controls the heater 412h so that the first-sub-tank ink temperature becomes equal to the preset first-sub-tank ink temperature in printing. The heater 412h is controlled to perform heating or to stop heating.

The controller 50 determines whether the printing process has ended (step S23). When not changing the preset first-sub-tank ink temperature to a different value (step S21: NO), the process proceeds to step S23. When the printing process has not ended (step S23: NO), the process proceeds to step S17. When the printing process has ended (step S23: YES), the process proceeds to step S16. In the case of NO in step S23, the controller 50 may set the preset dissolving-section ink temperature in printing to the initial value (e.g., temperature b). The controller 50 may set the preset first-sub-tank ink temperature in printing to the initial value (e.g., temperature c).

Herein, with reference to FIG. 10 and FIG. 11, the effect of controlling the preset dissolving-section ink temperature according to the first-sub-tank ink temperature will be described. An example of the present embodiment will be described with reference to FIG. 10. FIG. 10 shows the ink temperature [° C.] at the liquid delivery section 40 with respect to the ink discharge time [s] in the temperature control process of the inkjet recording apparatus 1. Herein, the ink flow rate is 6.1 cc/s. The ink temperature [° C.] of the liquid delivery section 40 includes the dissolving-section ink temperature [° C.], the first-sub-tank ink temperature [° C.], and the preset dissolving-section ink temperature [° C.]. Each value in FIG. 10 is a control value or a measurement value while the temperature control process or the printing process is executed by the inkjet recording apparatus 1.

As shown in FIG. 10, first, the first sub-tank ink temperature decreases from the target temperature in step S17 and step S18. In step S19, the preset dissolving-section ink temperature is increased, and heating by the heater 4213h is controlled. By repetitively executing steps S17 to S19, the preset dissolving-section ink temperature section is increased stepwise multiple times. By the heating control at this time, the dissolving-section ink temperature rises in accordance with the rise of the preset dissolving-section ink temperature.

As the dissolving-section ink temperature rises, the ink having the risen temperature is delivered from the dissolving section 4213 to the first sub tank 412. Accordingly, the first-sub-tank ink temperature also rises to the target temperature. When the temperature decrease of the ink in the first sub tank is recovered, the defoaming ability is recovered, so that the defoaming speed becomes equal to the foaming speed. Accordingly, the ink in the first sub tank 412 is defoamed.

A comparative example of the above-described example will be described with reference to FIG. 11. Similarly to the above-described example, FIG. 11 shows the ink temperature [° C.] of the liquid delivery section 40 with respect to the ink discharge time [s] in the temperature control of the comparative example of the inkjet recording apparatus 1. Herein, the ink flow rate is 6.0 cc/s. In the comparative example, the dissolving-section ink temperature is detected, and the heater 4213h of the dissolving section 4213 is controlled such that the dissolving-section ink temperature gets closer to the target temperature during the printing process.

As illustrated in FIG. 11, first, the first-sub-tank ink temperature decreases from the target temperature. Since the dissolving-section ink temperature does not decrease from the target temperature, the preset dissolving-section ink temperature is not changed, and the first sub tank 412 is not heated. When the first-sub-tank ink temperature decreases, the defoaming ability decreases, so that the foaming speed exceeds the defoaming speed. Accordingly, the ink in the first sub tank 412 is foamed.

Next, with reference to FIG. 12, the advantageous effect of controlling the preset first-sub-tank temperature according to the dissolving-section ink temperature will be described. FIG. 12 shows various temperatures of the liquid delivery section 40 with respect to time in the temperature control process of the inkjet recording apparatus 1. The various temperatures of the liquid delivery section 40 include the dissolving-section ink temperature, the preset first-sub-tank ink temperature, the first-sub-tank ink temperature, and the preset dissolving-section ink temperature. Each value in FIG. 12 is a control value or a measurement value while the temperature control process or the printing process is executed by the inkjet recording apparatus 1.

As shown in FIG. 12, first, in step S20 and step S21, the dissolving-section ink temperature decreases from the target temperature. To cover the decrease in the ink temperature of the dissolving section 4213, in step S22, the preset first-sub-tank ink temperature is raised from the initial temperature in consideration of the time constant, and heating by the heater 412h is controlled. At this time, the ink in the dissolving section 4213 flows into the first sub tank 412 with a time lag corresponding to the time constant. Therefore, the ink flowing into the first sub tank 412 with the time lag is heated according to the raised preset first-sub-tank ink temperature. Thus, fluctuations of the first-sub-tank ink temperature from the target temperature are restrained. Based on the restrained fluctuations of the ink temperature in the first sub tank 412, the preset dissolving-section ink temperature is adjusted in steps S17 to S19, so that the dissolving-section ink temperature is also adjusted.

As described above, according to the present embodiment, the inkjet recording apparatus 1 includes the inkjet head 24a, the liquid delivery section 40, the heaters 4213h and 412h as the adjustment section, and the controller 50. The inkjet head 24a ejects ink. The liquid delivery section 40 delivers ink. The heaters 4213h and 412h adjust the ink temperature in the liquid delivery section 40 on the upstream of the inkjet head 24a. With the heaters 4213h and 412h, the controller 50 adjusts the ink temperature in the liquid delivery section 40 on the upstream side to defoam the ink. By defoaming the ink by controlling the ink temperature in the channel, it is possible to reduce air bubbles during the printing operation without interrupting the printing operation. Therefore, it is possible to suppress apparatus troubles and a decrease in print quality caused by air bubbles. As an example of apparatus troubles caused by air bubbles, the liquid level may be erroneously detected when air bubbles of ink adhere to the float of the liquid level sensor F1 in the first sub tank 412. Since air bubbles are not ejected from the nozzles of the inkjet head 24a, deterioration in printing quality is suppressed.

The liquid delivery section 40 includes the main tank 411 as a storing section, the liquid channel 42, the dissolving section 4213, and the first sub tank 412 as a keeping-warm section in this order from the upstream toward the inkjet head 24a. The main tank 411 stores ink. The dissolving section 4213 dissolves ink. The first sub tank 412 keeps the ink warm. The controller 50 defoams the ink from the dissolving section 4213 to the first sub tank 412 by adjusting the temperature of the heaters 4213h and 412h. Therefore, the ink temperature in the flow channel to the inkjet head 24a can be effectively controlled. Thus, air bubbles can be reduced during the printing operation, and apparatus troubles caused by air bubbles and a decrease in printing quality can be suppressed.

The inkjet recording apparatus 1 includes the temperature detection section 433 that detects the ink temperature of the first sub tank 412. The heater 4213h heats the ink in the dissolving section 4213. The controller 50 changes the preset temperature of the heater 4213h during the printing operation so that the detected ink temperature in the first sub tank 412 becomes equal to the target temperature. Thus, the ink temperature in the upstream dissolving section 4213 is appropriately adjusted according to the change in the ink temperature of the first sub tank 412. Thus, the ink is kept at an appropriate temperature in the dissolving section 4213 and flows into the first sub tank 412. Accordingly, the ink is defoamed.

The inkjet recording apparatus 1 includes the temperature detection section 431 that detects the ink temperature of the dissolving section 4213. The heater 412h heats the ink in the first sub tank 412. The controller 50 changes the preset temperature of the heater 412h so that the detected ink temperature of the dissolving section 4213 reaches the target temperature in the printing operation. Therefore, based on a change in the ink temperature of the dissolving section 4213, the temperature of the ink flowing into the downstream first sub tank 412 is controlled to an appropriate temperature in the first sub tank 412. Accordingly, the ink is defoamed.

Based on the detected ink temperature of the dissolving section 4213, the controller 50 changes the preset temperature of the heater 412h, based on the time constant calculated from the ink channel volume and the ink flow rate between the dissolving section 4213 and the first sub tank 412. Therefore, based on the change in the ink temperature of the dissolving section 4213, the ink is made to have an appropriate temperature when flowing into the downstream first sub tank 412. Accordingly, the ink is defoamed.

The controller 50 acquires the ink flow rate between the dissolving section 4213 and the first sub tank 412 from the flow rate measurement section 44. Therefore, the time constant can be accurately calculated, and the ink temperature can be adjusted at accurate timing by using the accurate time constant. Accordingly, the ink is defoamed.

The inkjet recording apparatus 1 includes the temperature detection sections 431 and 432 as a third temperature detector and the temperature detection sections 433 and 434 as a fourth temperature detector. The temperature detection section 431 detects the dissolving-section ink temperature of the dissolving section 4213. The temperature detection section 432 detects the dissolving-section tank temperature of the dissolving section 4213. The temperature detection section 433 detects the first-sub-tank ink temperature of the first sub tank 412. The temperature detection section 434 detects the first-sub-tank temperature of the first sub tank 412. When the inkjet printing apparatus 1 is not in the printing operation (the apparatus 1 is on standby), the controller 50 controls the temperature of the heater 4213h so that the detected dissolving-section ink temperature or dissolving-section tank temperature of the dissolving section 4213 reaches the target temperature. When the inkjet printing apparatus 1 is not in the printing operation (the apparatus 1 is on standby), the controller 50 controls the temperature of the heater 412h so that the detected first-sub-tank ink temperature or first-sub-tank temperature of the first sub tank 412 reaches the target temperature. Therefore, when the ink does not flow in the liquid delivery section 40 during standby, the ink temperature in the dissolving section 4213 or the first sub tank 412 can be appropriately adjusted according to the detected temperature.

The ink is UV ink or phase-change gel ink. Therefore, the UV ink or the phase-change gel ink, which need heating, can be appropriately defoamed.

In the above description, the ROM is used as an example of a computer-readable medium of the program according to the present disclosure. However, the present disclosure is not limited to this example. As other computer-readable media, a nonvolatile memory (e.g., a flash memory) and a portable recording medium (e.g., a CD-ROM) can be used. Furthermore, a carrier wave is also applicable to the present disclosure as a medium that provides data of the program according to the present disclosure via a communication line.

The above-described embodiment is an example of the inkjet recording apparatus, the temperature control method, and the program according to the present disclosure. The present disclosure is not limited thereto.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inkjet recording apparatus comprising:
an inkjet head that ejects ink;
a liquid delivery section that delivers the ink;
an adjustment section that adjusts an ink temperature in the liquid delivery section at an upstream side of the inkjet head; and
a hardware processor that defoams the ink by causing the adjustment section to adjust the ink temperature in the liquid delivery section at the upstream side.

2. The inkjet recording apparatus according to claim 1, wherein:
the liquid delivery section includes following in order from an upstream side toward the inkjet head:
a storing section that stores the ink;
a liquid channel through which the ink flows;
a dissolving section that dissolves the ink; and
a keeping-warm section that keeps the ink warm, and
the hardware processor defoams the ink between the dissolving section and the keeping-warm section by adjusting a temperature of the adjustment section.

3. The inkjet recording apparatus according to claim 2, further comprising a first temperature detector that detects the ink temperature in the keeping-warm section, wherein:
the adjustment section includes a first heater that heats the ink in the dissolving section, and
during a printing operation, the hardware processor changes a preset temperature of the first heater so that the detected ink temperature in the keeping-warm section becomes a target temperature.

4. The inkjet recording apparatus according to claim 2, further comprising a second temperature detector that detects the ink temperature in the dissolving section, wherein:
the adjustment section includes a second heater that heats the ink in the keeping-warm section, and
during a printing operation, the hardware processor changes a preset temperature of the second heater so that the detected ink temperature in the dissolving section becomes a target temperature.

5. The inkjet recording apparatus according to claim 4, wherein, depending on the detected ink temperature in the dissolving section, the hardware processor changes the preset temperature of the second heater, based on a time constant calculated from an ink channel volume and an ink flow rate between the dissolving section and the keeping-warm section.

6. The inkjet recording apparatus according to claim 5, wherein:
the hardware processor obtains the ink flow rate from a flow rate measurement section that measures the ink flow rate between the dissolving section and the keeping-warm section, or
the hardware processor calculates the ink flow rate from an image data difference.

7. The inkjet recording apparatus according to claim 2, further comprising:
a third temperature detector that detects the ink temperature or a tank temperature of the dissolving section; and
a fourth temperature detector that detects the ink temperature or a tank temperature of the keeping-warm section,
wherein the adjustment section includes:
a first heater that heats the ink in the dissolving section; and
a second heater that heats the ink in the keeping-warm section,
wherein in a state other than a printing operation, the hardware processor controls a temperature of the first heater so that the detected ink temperature or tank temperature of the dissolving section becomes a target temperature, and the hardware processor controls a temperature of the second heater so that the detected ink temperature or tank temperature of the keeping-warm section becomes a target temperature.

8. The inkjet recording apparatus according to claim 1, wherein the ink is UV ink.

9. The inkjet recording apparatus according to claim 1, wherein the ink is phase-change gel ink.

10. A temperature adjustment method for an inkjet recording apparatus that includes an inkjet head that ejects ink, a liquid delivery section that delivers the ink, and an adjustment section that adjusts an ink temperature in the liquid delivery section at an upstream side of the inkjet head, the method comprising defoaming the ink by causing the adjustment section to adjust the ink temperature in the liquid delivery section at the upstream side.

11. A non-transitory computer-readable storage medium storing a program for an inkjet recording apparatus that includes an inkjet head that ejects ink, a liquid delivery section that delivers the ink, and an adjustment section that adjusts an ink temperature in the liquid delivery section at an upstream side of the inkjet head, the program causing a computer of the inkjet recording apparatus to defoam the ink by causing the adjustment section to adjust the ink temperature in the liquid delivery section at the upstream side.
